(19) United States
(12) Patent Application Publication
(10) Pub. No.: US 2012/0330785 A1
(43) Pub. Date: Dec. 27, 2012

(54) SYSTEMS AND METHODS FOR PURCHASING VIRTUAL GOODS IN MULTIPLE VIRTUAL ENVIRONMENTS

(75) Inventors: Timothy John HAMICK, Dallas, TX (US); Nicholas John Mitham, Cambridge (GB); Matthew Peter Warneford, Leeds (GB); Sean Rodger Thompson, Yeadon (GB)

(73) Assignee: WoGo LLC, Dallas, TX (US)

(21) Appl. No.: 13/167,506

(22) Filed: Jun. 23, 2011

(51) Int. Cl. G06Q 30/00

(52) U.S. Cl. 705/26.41

(57) ABSTRACT

A transaction system for purchasing virtual goods, which are to be expressed within multiple virtual environments, may receive a selection from a user for one or more virtual goods. The transaction system may receive a selection for a plurality of virtual environments within which the selected virtual good(s) are to be expressed upon completion of the purchase transaction.

### FIELD OF THE DISCLOSURE

The invention relates to selling individual virtual goods that can be expressed within multiple virtual environments, and to facilitating user selection of the virtual environments a virtual good should be expressed in at the time of purchase.

### BACKGROUND

Virtual environments, including virtual spaces, virtual worlds, electronic (online) games, and interactive electronic social media, may be known.

Users of these virtual environments may use separate user accounts in multiple virtual environments. For example, a user may use separate accounts for Facebook™, World of Warcraft®, Call of Duty®, Club Penguin®, and/or other virtual environments. A user may use multiple user accounts for multiple virtual environments that may be titles of different games under the same franchise and/or released by the same company (e.g. Activision®), e.g. Call of Duty®: Black Ops, Call of Duty®: Elite, Call of Duty®: Modern Warfare 3, etc. A user may use multiple user accounts for the same virtual environment, e.g. to play a game using different characters and/or to play a game on different platforms. A user may have one user account for multiple virtual environments.

Transaction systems configured to sell individual virtual goods for a particular virtual environment may be known. An example of a known transaction system may be a virtual store, offering for sale virtual goods for a particular virtual environment, such as, e.g. SimCity™. Another example of a known transaction system may be the in-game (or “in-app”) purchasing system available in some Apple iPhone™ applications and Sony PlayStation®Network games.

A user who uses and/or maintains multiple user accounts may be burdened by managing the use of multiple transaction systems, multiple virtual inventories, multiple virtual currencies, and/or multiple copies/versions of personal payment information (e.g. credit card information). In a given virtual environment it may be unknown (and possibly unknowable) that one user account may be associated with another user account, particularly in a different virtual environment. As such, in relation to a given user account in a given virtual environment, no knowledge may be available regarding virtual inventories, virtual currencies, and/or any other information related to another user account, despite being associated with the given user account in the given virtual environment.

### SUMMARY

One aspect of the disclosure relates to systems and methods of selling virtual goods. The virtual goods may be expressed, upon purchase, in a plurality of virtual environments. At the virtual point of sale, a user (or customer) may select one or more virtual goods to purchase in a purchase transaction. The user may select for which virtual environments the selected virtual good(s) is/are to be expressed subsequent to the purchase transaction. Upon receipt of a payment from the user, the purchase transaction may be completed and the selected virtual good(s) may be made available for expression in the selected virtual environment(s). These purchase transactions may be conducted within a virtual store. The appearance, interface, functionality, and/or other features of the virtual store may be customized to individual users.

A transaction system configured to conduct such purchase transactions may be configured to communicate with a plurality of virtual environment servers that host a plurality of different virtual environments. Such communication may be conducted, for example, via application programming interfaces between the transaction system and the virtual environment servers of the individual virtual environments. The transaction system may include one or more transaction servers configured to facilitate transactions with users. The users may interact with the transaction server via client computing platforms in communication with the transaction server. The client computing platforms may provide access to the virtual environments hosted by the virtual environment servers for the users. The transaction server may be configured to execute one or more of a user access module, a user account module, a currency module, an inventory module, a payment module, an environment interaction module, a store module, and/or other modules.

The store module may be configured to present a user with an offered set of virtual goods for purchase. Individual ones of the virtual goods may be expressable within a plurality of the different virtual environments. Presentation to the user of the offered set of virtual goods may be made within a user interface presented to the user by a client computing platform associated with the user. The store module may be configured to receive a first user-selection of an offered virtual good. The selection may be received from the user via the client computing platform.

The store module may be configured to present a set of the virtual environments in which the selected virtual good may be expressed. Said presentation may implemented using identifiers that represent one ore more virtual environments. The individual virtual environments, and/or their representative identifiers, may be selectable. This presentation may be provided to the user, for example, via a user interface presented to the user on the client computing platform. Selection of one of the virtual environments, and/or their representative identifiers, may indicate that upon purchase (i.e. upon completion of the purchase transaction for an agreed-upon amount of payment) the selected individual virtual good should be expressed within the selected virtual environment. Selection may require associating the selected virtual good with the user in the selected virtual environment. For example, the selected good may be included in the virtual inventory of a user account and/or a user character associated with the user in the selected virtual environment. The store module may be configured to receive such a selection.

The store module may be configured such that presentation of the virtual environments in which a selected good may be expressed includes expression information related to the different expressions of the virtual good. For example, expression information for the selected virtual good within a given virtual environment may include visual information related to the expression (e.g., size, shape, color, visual representation, and/or other information), audio information related to the expression (e.g., sounds emitted, pitch, sample sound, and/or other information), information related to a (virtual) metric supplemented by the selected virtual good in the given virtual environment (e.g., experience points, skill points, manna, gold, and/or other information related to metrics), and/or other information.

The store module may be configured such that the required amount of the payment to complete a purchase transaction may be adjusted based on which virtual environments are selected per selected individual virtual good. The price of an individual virtual good may be provided to the user, for example, via a user interface presented to the user on the client computing platform. The user interface may present a cumulative total amount representing the purchase price (i.e. the required amount of the payment) of the currently selected virtual goods for the currently selected virtual environments. In some implementations, the user interface may present a purchase price per virtual environment (generically or for specific virtual environments). Pricing structures, sales and/or marketing schemes/strategies, and/or other ways to entice a user to purchase (more) virtual goods (for more virtual environments) are contemplated, e.g. in accordance with common economic principles regarding the purchase of virtual and/or consumer goods.

The inventory module may be configured to present inventory information to a user in one or more virtual environments and/or the transaction system. Inventory information may include a user's virtual inventory in the transaction system and/or one or more virtual environments. The user's virtual inventory may include the virtual goods associated with the user. The user's virtual inventory may include the virtual environments within which a given virtual good associated with the user may be expressed. Upon completion of a purchase transaction in the transaction system, a purchased virtual good may be added to the inventory information, and/or the virtual environments in which the purchased virtual good may be expressed may be added to the inventory information.

The inventory module may be configured to present a user with an offered set of virtual goods for purchase, such that the presentation may occur (or may seem to occur) in a given virtual environment, which may be external and/or remote to the transaction system. The presentation may seem to occur, to a user, within the user interface of the given virtual environment. The presentation may be implemented as an inventory user interface provided by the inventory module to a client computing platform 14 associated with the user. This inventory user interface may be shared, overlaid, embedded, integrated, and/or otherwise combined with the user interface of the given virtual environment. For example, a corner of a display of a client computing platform, wherein the entire display may be originally intended to be dedicated to present the user interface of a given virtual environment to a user, may be used by the inventory module of the transaction system to present offered virtual goods for purchase to a user of the given virtual environment via the inventory user interface, whilst the user may be interacting with the given virtual environment. The presentation of the inventory user interface may be independent and/or separate from the presentation of the user interface of the given virtual environment.

The currency module may be configured to facilitate the use of a virtual currency in the transaction system (e.g. in the store module) and/or one or more virtual environments. Virtual currency may be used to acquire virtual goods in the transaction system, which may add to a user's virtual inventory for one or more virtual environments. Virtual currency may be won through a particular achievement, such as completion of a particular task or mission, awarded/gifted by another user and/or other entity within one or more virtual environments, purchased with real world money/currency, and/or obtained through other means. Virtual goods may be transferable to other users of the transaction system and/or one or more users in one or more virtual environments.

The currency module may be configured to receive a payment from a user in the course of completing a purchase transaction, such that the amount of the payment corresponds to the selected virtual good(s) to be purchased for the selected virtual environment(s). In exchange for value (e.g. virtual currency held in credit by the currency module, real currency, promotional codes, coupons, etc., or any combination thereof) corresponding to the amount of the payment, expression within the appropriate virtual environments of the one or more virtual goods pertaining to the present purchase transaction may be made available. The currency module may be configured to manage (storage for and/or access to) payment information of a user. Payment information may include information linking a user with a bank account, a PayPal™ account, a credit card, a pre-stored value, and/or other payment information or value or combination thereof that may be used to pay for a purchase transaction. The amount of the payment for a particular virtual good may be adjusted based on which virtual environments are indicated through the second user-selection.

The environment interaction module may be configured to, responsive to receipt of a payment of the appropriate amount, transmit communications to the selected virtual environment(s) that cause and/or instruct the selected virtual good(s) to be available for expression in accordance with the present purchase transaction. The functionality of the environment interaction module may be accomplished through the use of application programming interfaces (APIs) that are specific to a given virtual environment.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings and/or examples are for the purpose of illustration and/or description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a transaction system configured to sell virtual goods for expression within a plurality of virtual environments.

FIG. 2 illustrates an exemplary embodiment of a virtual store interface.

FIG. 3 illustrates an exemplary external virtual environment interface that includes an inventory user interface.

FIG. 4 illustrates a method for conducting purchase transactions in accordance with one or more implementations.

FIG. 5 illustrates a method for conducting purchase transactions in accordance with one or more implementations.

### DETAILED DESCRIPTION

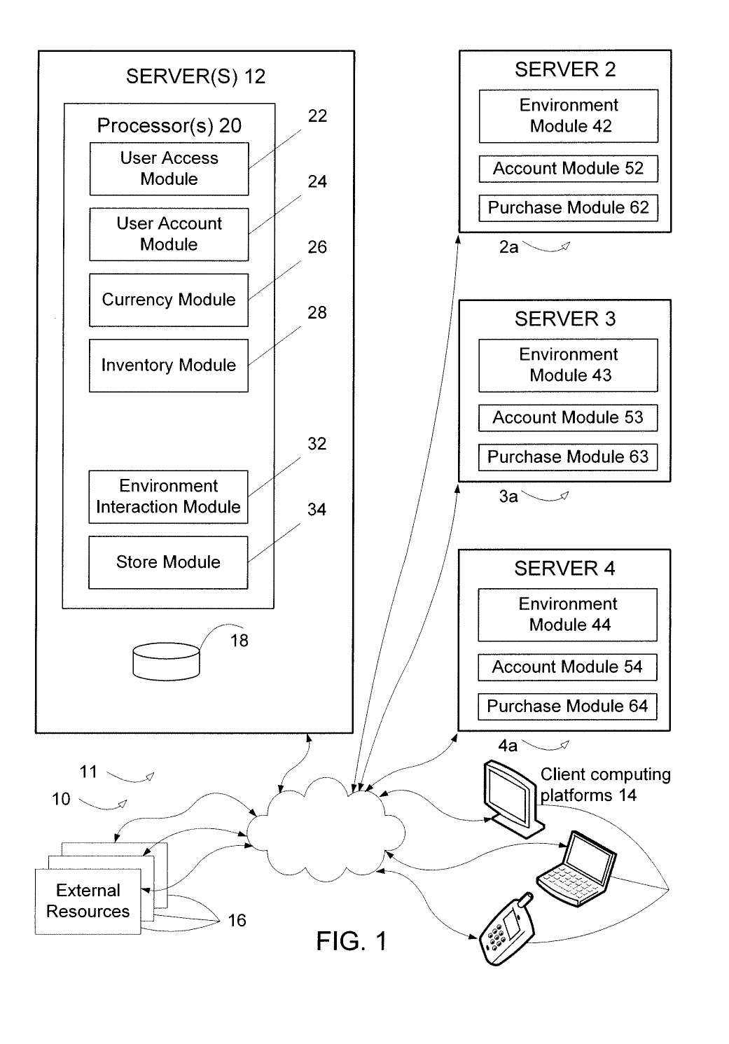

FIG. 1 illustrates a transaction system 10 configured to sell virtual goods for expression within a plurality of virtual environments. Transaction system 10 may be referred to as a virtual store 11, and both terms may be used interchangeably throughout. Customers of virtual store 11 may be referred to as users. As used herein, a “virtual environment” may include a virtual space, one or more interactive, electronic social media, and/or other virtual environments. Any virtual environment described herein may use a client/server architecture (e.g. via client computing platforms), and/or any other architecture known for providing virtual environments to users. A virtual environment server may be configured to provide a virtual environment (e.g. via one or more of client computing platforms 14).

Transaction system 10 may include a plurality of virtual environment servers, e.g. server 2, server 3, and/or server 4, as shown in FIG. 1. For example, server 2 may be configured to provide virtual environment 2a, server 3 may be configured to provide virtual environment 3a, and server 4 may be configured to provide virtual environment 4a. The scope of the implementations described herein is not intended to be limited by a particular number of virtual environment servers and/or virtual environments. Virtual environments 2a, 3a, and 4a may include multiple virtual places or virtual locations that may be inter-connected to each other and/or to transaction system 10. In some implementations, access to transaction system 10 may be integrated into one or more of virtual environments 2a, 3a, and 4a.

Transaction system 10 may be configured to sell virtual goods to be expressed within a plurality of virtual environments (e.g. virtual environments 2a, 3a, and/or 4a). As used herein a “virtual good” may be wearable, storable, tradable, sellable, transferable, destroyable, usable, inhabitable, ridable, and/or disposable within the virtual environments. A virtual good may be classified as one or more of decorative, functional, access-driven, behavioral, and/or other classifications. A virtual good may include, without limitation, an object with or without abilities, an ingredient, a virtual mineral or ore, a virtual herb, leaf, stem, seeds or root, a protective object, a tool, a weapon, a pet, a vehicle, a mount, a map, clothing, documents, music, newspapers, magazines, a digital copy of a video game, other media, artwork and/or other goods or items.

Users of transaction system 10 may be users of one or more virtual environments (e.g. virtual environments 2a, 3a, and/or 4a). When a particular virtual good is sold to a user through transaction system 10, that user may be said to have purchased the particular virtual good through a purchase transaction. A purchase transaction may include a single exchange of value by a user (e.g. virtual currency, real currency, promotional codes, coupons, etc., or any combination thereof) for (expression within the appropriate virtual environment of) one or more virtual goods. Transaction system 10 and/or virtual environments 2a, 3a, and/or 4a may enable synchronous and/or asynchronous interactions, public, private, and/or semi-private interactions, text-based interactions, audio-based interactions, computer-graphics-based interactions, video-based interactions, and/or other interactions of users. Providing transaction system 10 and/or virtual environments 2a, 3a, and/or 4a may include network-based hosting thereof. Providing transaction system 10 to users may include hosting transaction system 10 over a network for a third party (and/or multiple third parties). A third party may correspond to a virtual environment external to transaction system 10.

Transaction system 10 may include one or more of virtual store server(s) 12, external resource(s) 16, client computing platform(s) 14, and/or other components. Virtual store server(s) 12 may be configured to communicate with one or more client computing platforms 14 according to a client/server architecture to provide transaction system 10 to users via one or more client computing platforms 14. The client computing platforms 14 may be configured to interact with virtual store server(s) 12 to supplement the functionality provided to users with respect to transaction system 10. For example, client computing platforms 14 may interface with virtual store server(s) 12 via one or more application programming interfaces (APIs). Client computing platforms 14 may provide access to the virtual environments hosted by the virtual environment servers for the users.

The virtual store server 12 may be configured to execute one or more computer program modules. The one or more computer program modules may include one or more of a user access module 22, a user account module 24, a currency module 26, an inventory module 28, an environment interaction module 32, a store module 34, and/or other modules.

User access module 22 may be configured to manage user access to transaction system 10. Access to transaction system 10 may be granted pursuant to setup of a user account for transaction system 10. Access to transaction system 10 may require one or more of a user account, a user name and/or user identifier, security login information (e.g. an access code and/or password), and/or other information. Other functionalities attributed herein to modules of virtual store server(s) 12 may be unavailable to a user until access to transaction system 10 has been authorized through user access module 22. User access module 22 may be configured to generate a user interface for presentation to users through which entry and/or selection of the required authentication information may be received. The user interface may be presented to the users, for example, through client computing platforms 14.

User account module 24 may be configured to manage (storage for and/or access to) account information and/or a user profile of a user. Account information and/or a user profile may include information stored by server 12, information stored by one or more client computing platforms 14, information stored by one or more of servers 2, 3, and 4, and/or other storage locations. Account information for a specific user may be included within a user profile associated with the specific user. Account information may include information identifying a user (e.g. a username or handle, a number, an identifier, and/or other identifying information), user information, subscription information, virtual currency account information (e.g., related to currency held in credit for a user), relationship information (e.g., information related to relationships between users in a virtual environment), usage information, demographic information, settings, preferences, customizations, and/or other account information.

Account information may include one or more account identifiers corresponding to user accounts associated with one or more virtual environments (e.g. virtual environments 2a, 3a, and/or 4a). Account information may include information related to past interactions, achievements, evaluations, and/or purchases pertaining to a user. Account information may include information derived by analysis, provided information of a user, stated information, account history of a user, browsing history of a user, a client computing platform identification associated with a user, a phone number associated with a user, and/or other account information.

Store module 34 may be configured to present a user with an offered set of virtual goods for purchase. Individual ones of the virtual goods may be expressable within a plurality of the different virtual environments. Inclusion of a given virtual good in the offered set of virtual goods may be based on ability of the given virtual good to be expressed within a particular virtual environment. This particular virtual environment may be associated with the user accounts corresponding to the account identifiers included in the account information from user account module 24. Presentation to the user of the offered set of virtual goods may be made within a user interface presented to the user by a client computing platform associated with the user.

Store module 34 may be configured to receive a selection of individual virtual goods from the offered set of virtual goods. The selection may be received from the user via client computing platform 14. For example, transaction system 10 may offer (to a particular user) for purchase a particular virtual good associated with, e.g., virtual environment 4a if the particular user has a user account for virtual environment 4a, as indicated, via user account module 24, in the account information of the particular user. In some implementations, transaction system 10 may offer (to a particular user) for purchase a particular virtual good associated with a particular virtual environment regardless of whether the particular user has a user account for that particular environment.

Store module 34 may be configured to present the user, e.g. through a user interface, with selectable identifiers representing one or more virtual environments (e.g. virtual environments 2a, 3a, and 4a) within which a selected individual virtual good may be expressable such that an identifier may be associated with a selected individual virtual good. Store module 34 may be configured to receive a selection responsive to said presentation. Selection of one of the identifiers representing virtual environments may indicate that upon purchase (i.e. upon completion of the purchase transaction for an agreed-upon amount of payment) the selected individual virtual good should be expressed within the selected virtual environment. Selection may require associating the selected virtual good with the user in the selected virtual environment, e.g. to verify whether the user may be allowed to purchase a particular virtual good based on the level, status, accomplishments, and/or other status information related to the user. “Selection” of a virtual environment or identifier may include manual entry by a user of a virtual environment and/or an identifier associated therewith.

Store module 34 may be configured such that presentation of the virtual environments in which a selected good may be expressed includes expression information related to the different expressions of the virtual good. For example, expression information for the selected virtual good within a given virtual environment may include visual information related to the expression (e.g., size, shape, color, visual representation, and/or other information), audio information related to the expression (e.g., sounds emitted, pitch, sample sound, and/or other information), information related to a (virtual) metric supplemented by the selected virtual good in the given virtual environment (e.g., experience points, skill points, manna, gold, and/or other information related to metrics), and/or other information.

Store module 34 may be configured such that the required amount of the payment to complete a purchase transaction may be adjusted based on which virtual environments are selected per selected individual virtual good. The price of an individual virtual good may be provided to the user, for example, via a user interface presented to the user on client computing platform 14. The user interface may be presented while the user makes selections of virtual environments for a virtual good being purchased. The user interface may present a cumulative total amount representing the purchase price (i.e. the required amount of the payment) of the currently selected virtual goods for the currently selected virtual environments. In some implementations, the user interface may present a purchase price per virtual environment (generically or for specific virtual environments). The purchase price may be adjusted based on whether use of a selected virtual good may be exclusive to one or more virtual environments, e.g. such that a virtual good cannot be used in multiple virtual worlds at the same time. Pricing structures, sales and/or marketing schemes/strategies, and/or other ways to entice a user to purchase (more) virtual goods (for more virtual environments) are contemplated, e.g. in accordance with common economic principles regarding the purchase of virtual and/or consumer goods.

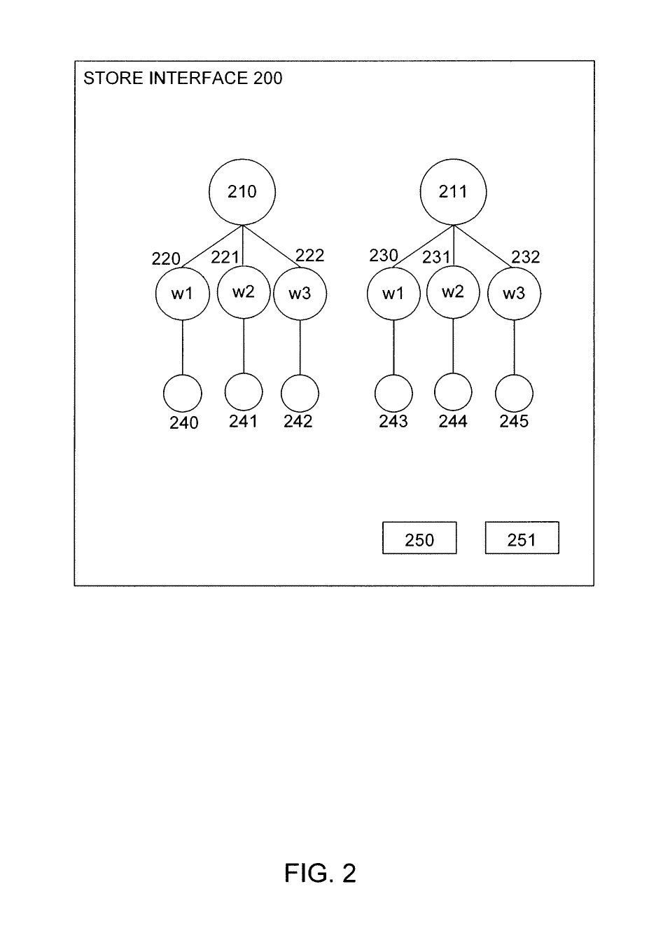

By way of illustration, FIG. 2 illustrates an exemplary embodiment of a virtual store interface 200. Store module 34 may present a user with an offered set of virtual goods for purchase through virtual store interface 200. Elements of virtual store interlace 200 may be implemented as fields configured to receive entry and/or selection from a user. The fields may include one or more of a text entry field, a set of selectable menu items, a selectable field, and/or other fields configured to receive entry and/or selection from a user. Object 210 and object 211 may represent virtual goods for sale in transaction system 10. Object 210 and object 211 may be implemented as selectable fields in virtual store interface 200. Identifiers 220, 221, and 222 may be associated with object 210 and represent different virtual environments, e.g. virtual environments 2a, 3a, and 4a, on condition that the virtual environment represented by identifiers 220, 221, and 222 may be able to express the particular virtual good represented by object 210. Identifiers 230, 231, and 232 may be associated with object 211 and represent different virtual environments, e.g. virtual environments 2a, 3a, and 4a, on condition that the virtual environment represented by identifiers 230, 231, and 232 may be able to express the particular virtual good represented by object 211. Identifiers 220, 221, 222, 230, 231, and 232 may be implemented as selectable fields in virtual store interface 200.

Object 210 and object 211 in FIG. 2 may be associated with a different number of identifiers representing virtual environments. The first user selection in virtual store interface 200 may represent the selection by a user among objects such as object 210 and object 211. For example, the user may select both object 210 and object 211 by clicking/tapping on object 210 and object 211 in virtual store interface 200. The second user selection in virtual store interface 200 may represent the selection by a user of identifiers representing different virtual environment for objects 210 and 211, corresponding to the different virtual environments that the user wishes to purchase virtual goods for. For example, the user may select identifiers 220, 221, 230, and 232 by clicking/tapping on the respective fields in virtual store interface 200.

Expressions 240, 241, 242, 243, 244, and 245 in FIG. 2 may represent expressions of a virtual good in a particular virtual environment. Expression 240 may be associated with the virtual environment indicated by identifier 220, and thus object 210. In similar fashion expressions 241, 242, 243, 244, and 245 may be associated with identifiers 221, 222, 230, 231, and 232, respectively. Virtual store interface 200 may not present these expressions to a user of transaction system 10, though a purchase of a virtual good would trigger, e.g., operation of environment interaction module 32.

Field 250 in FIG. 2 may be an information field used in virtual store interface 200 to present the amount to be paid to purchase the current selection of virtual goods and associated virtual environment, corresponding to the first user-selection and the second user-selection. Field 251 may be a selectable field in virtual store interface 200 which triggers, upon selection, a confirmation from a user that a particular purchase transaction may be authorized.

Referring to FIG. 1, inventory module 28 may be configured to present inventory information to a user in one or more of virtual environments 2a, 3a, and 4a and/or transaction system 10. Inventory information may include a user's virtual inventory in transaction system 10 and/or one or more of virtual environments 2a, 3a, and 4a. The user's virtual inventory may include the virtual goods associated with the user. The user's virtual inventory may include the virtual environments within which a given virtual good associated with the user may be expressed. Upon completion of a purchase transaction in transaction system 10, a virtual good may be added to the inventory information, and/or the virtual environments in which the purchased virtual good may be expressed may be added to the inventory information.

Inventory module 28 may be configured to present a user with an offered set of virtual goods, in one or more of virtual environments 2a, 3a, and 4a, for purchase, e.g. via transaction system 10. The presentation may occur (or may seem to occur) in a given virtual environment, which may be external and/or remote to transaction system 10. For example, inventory information of a user may be presented to a user whilst the user may be interacting with one or more of virtual environments 2a, 3a, and 4a. The presentation of virtual goods for purchase may seem to occur, to a user, within the user interface of a given virtual environment. The presentation may be implemented as an inventory user interface provided by inventory module 26 to a client computing platform 14 associated with the user. This inventory user interface may be shared, overlaid, embedded, integrated, and/or otherwise combined with the user interface of the given virtual environment. For example, a corner of a display of a client computing platform 14, wherein the entire display may be originally intended to be dedicated to present the user interface of a given virtual environment to a user, may be used by inventory module 26 of transaction system 10 to present offered virtual goods for purchase to a user of the given virtual environment via the inventory user interface, whilst the user may be interacting with the given virtual environment. The presentation of the inventory user interface may be independent and/or separate from the presentation of the user interface of the given virtual environment. A given virtual environment (or any of its constituent components) may initiate the described presentation by inventory module 28 through, e.g., an API call to transaction system 10. Upon completion of a purchase transaction through the inventory user interface, additional API calls and/or other transmitted communications may occur, which may result in a selected virtual good being added to the virtual inventory for the given virtual environment in accordance with the purchase transaction.

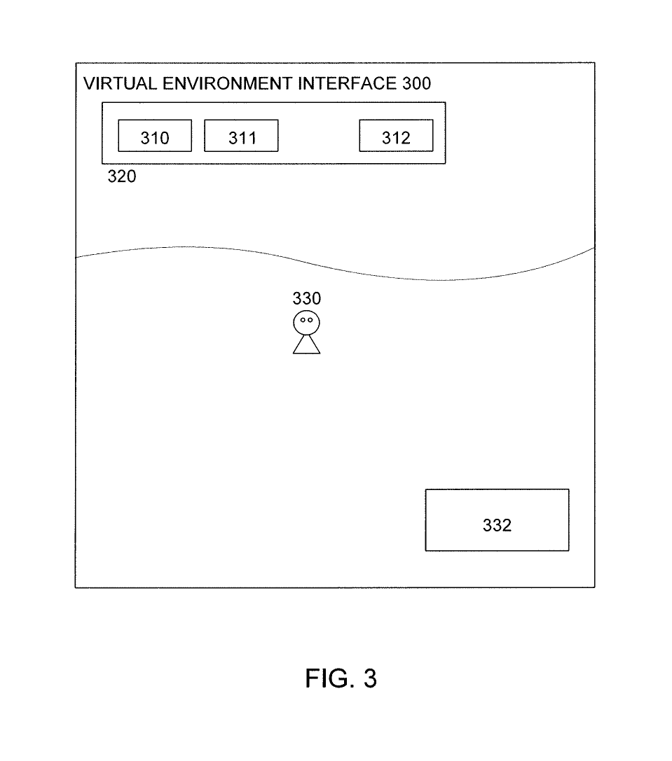

By way of illustration, FIG. 3 illustrates an exemplary external virtual environment interface 300 that includes an inventory user interface 320. A given virtual environment server, e.g. server 2, may present a user with an instance of a given virtual environment, e.g. virtual environment 2a, through virtual environment interface 300. Elements of virtual environment interface 300 may include avatar 330, one or more native interaction element(s) 332 (which may be specific to the implementation of the virtual environment associated with virtual environment interface 300), and/or other elements. Elements of virtual environment interface 300 may be implemented as fields configured to receive entry and/or selection from a user. The fields may include one or more of a text entry field, a set of selectable menu items, a selectable field, and/or other fields configured to receive entry and/or selection from a user.

Interface element 320 of virtual environment interlace 300 may represent an interface to transaction system 10, e.g. through one or more APIs, a plug-in, and/or another way to combine separate interfaces. Interface element 320 may be provided by transaction system 10, e.g. by inventory module 28 (not shown in FIG. 3) as an inventory user interface. Interface element 320 may include any of the elements described in relation to virtual store interface 200 (not shown in FIG. 3). For example, object 310 and object 311 may represent virtual goods for sale in transaction system 10. Object 310 and object 311 may be implemented as selectable fields in interface element 320, such that clicking/tapping on object 310 and object 311 selects the associated virtual goods for purchase. Field 312 may be a selectable field in interface element 320 which triggers, upon selection, a confirmation from a user that a particular purchase transaction, for example of the virtual goods represented by object 310 and 311, may be authorized.

Alternatively, and/or simultaneously, virtual goods that may not (yet) be part of a user's virtual inventory (in transaction system 10 and/or one or more of virtual environments 2a, 3a, and 4a) may be presented and/or offered for purchase to a user whilst the user may be interacting with one or more of virtual environments 2a, 3a, and 4a, for example through an inventory user interface 320 as described in relation to inventory module 28.

Referring to FIG. 1, currency module 26 may be configured to facilitate the use of a virtual currency in transaction system 10 and/or one or more virtual environments (e.g. one or more of virtual environments 2a, 3a, and 4a). Virtual currency may be used to acquire virtual goods in transaction system 10, which may add to a user's virtual inventory for one or more of virtual environments 2a, 3a, and 4a. Currency module 26 may hold virtual currency in credit for a user. Virtual currency may be won through a particular achievement, such as completion of a particular task or mission, awarded/gifted by another user and/or other entity within one or more virtual environments, purchased with real world money/currency, and/or obtained through other means. Virtual goods may be transferable to other users of the virtual store and/or one or more users in one or more virtual environments (e.g. virtual environments 2a, 3a, and/or 4a).

Currency module 26 may be configured to receive a payment from a user in the course of completing a purchase transaction, such that the amount of the payment corresponds to the selected virtual good(s) to be purchased for the selected virtual environment(s). In exchange for value (e.g. virtual currency held in credit by the currency module, virtual currency held in credit within an external virtual environment, real currency, promotional codes, coupons, etc., or any combination thereof) corresponding to the amount of the payment, expression within the appropriate virtual environments of the one or more virtual goods pertaining to the present purchase transaction may be made available. The currency module may be configured to manage (storage for and/or access to) payment information of a user. Payment information may include information linking a user with a bank account, a PayPal™ account, a credit card, a pre-stored value, and/or other payment information or value or combination thereof that may be used to pay for a purchase transaction. The amount of the payment for a particular virtual good may be adjusted based on which virtual environments are indicated through the second user-selection. By way of illustration (referring to FIG. 2) selection of field 251 may activate currency module 26.

Referring to FIG. 1, environment interaction module 32 may be configured to, responsive to receipt of a payment of the appropriate amount, transmit communications to one or more virtual environments (e.g. virtual environments 2a, 3a, and/or 4a) that cause and/or instruct the selected virtual good(s) to be available for expression in accordance with the present purchase transaction. The functionality of environment interaction module 32 may be accomplished through the use of APIs that are specific to a given virtual environment.

Virtual store server(s) 12 may include processor(s) 20, electronic storage 18, and/or other components. Virtual store server(s) 12 may include communication lines, or ports to enable the exchange of information with one or more networks (e.g. the Internet) and/or other computing platforms. Processor(s) 20 may be configured to provide information processing capabilities in virtual store server(s) 12 through one or more of hardware, software, and/or firmware. Processor(s) 20 may be configured to execute one or more computer program modules.

Though transaction system 10 may be described in certain sections herein as including virtual store server(s) 12, this is not intended to be limiting. Virtual store server(s) 12, or any component thereof, may be separate and distinct from transaction system 10. In some implementations, one or more functionalities attributed herein to virtual store server(s) 12 may be provided by one or more of servers 2, 3, 4, and/or one or more of client computing platforms 14. For example, virtual store server(s) 12 may be implemented by a cloud of computing platforms operating together. In some implementations, one or more functionalities attributed herein to one or more of servers 2, 3, 4, and/or one or more of client computing platforms 14 may be provided by (and/or incorporated in) a constituent component of virtual store server(s) 12.

Client computing platform(s) 14 may include one or more processors configured to execute computer program modules. The computer program modules may be configured to enable an expert or user associated with a given client computing platform 14 to interact with transaction system 10, virtual store 11, and/or external resources 16, and/or provide other functionality attributed herein to client computing platforms 14. By way of non-limiting example, the given client computing platform 14 may include one or more of a desktop computer, a laptop computer, a handheld computer, a NetBook, a Smartphone, a tablet, a gaming console, and/or other computing platforms.

External resources 16 may include sources of information, hosts and/or providers of virtual environments outside of transaction system 10 and/or virtual store 11, external entities participating with transaction system 10 and/or virtual store 11, external vendors, and/or other resources. In some implementations, some or all of the functionality attributed herein to external resources 16 may be provided by resources included in transaction system 10 and/or virtual store 11.

Electronic storage 18 may comprise electronic storage media that electronically stores information. The electronic storage media of electronic storage 18 may include one or both of system storage that may be provided integrally (i.e., substantially non-removable) with virtual store server(s) 12 and/or removable storage that may be removably connectable to virtual store server(s) 12 via, for example, a port (e.g., a USB port, a firewire port, etc.) or a drive (e.g., a disk drive, etc.). Electronic storage 18 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 18 may include one or more virtual storage resources (e.g., cloud storage, a virtual private network, and/or other virtual storage resources). Electronic storage 18 may store software algorithms, information determined by processor(s) 20, information received from virtual store server(s) 12, information received from client computing platforms 14, and/or other information that enables virtual store server(s) 12 to function as described herein.

Processor(s) 20 may be configured to provide information processing capabilities in virtual store server(s) 12. As such, processor(s) 20 may include one or more of a digital processor, an analog processor, a digital circuit designed to process information, an analog circuit designed to process information, a state machine, and/or other mechanisms for electronically processing information. Although processor(s) 20 may be shown in FIG. 1 as a single entity, this is for illustrative purposes only. In some implementations, processor(s) 20 may include a plurality of processing units. These processing units may be physically located within the same device, or processor(s) 20 may represent processing functionality of a plurality of devices operating in coordination. Processor(s) 20 may be configured to execute one or more computer program modules, including a user access module 22, a user account module 24, a currency module 26, an inventory module 28, an environment interaction module 32, a store module 34, and/or other modules. Processor(s) 20 may be configured to execute modules 22, 24, 26, 28, 32, and/or 34 by software; hardware; firmware; some combination of software, hardware, and/or firmware; and/or other mechanisms for configuring processing capabilities on processor(s) 20.

It should be appreciated that although modules 22, 24, 26, 28, 32, and 34 are illustrated in FIG. 1 as being co-located within a single processing unit, in implementations in which processor(s) 20 includes multiple processing units, one or more of modules 22, 24, 26, 28, 32, and/or 34 may be located remotely from the other modules. The description of the functionality provided by the different modules 22, 24, 26, 28, 32, and/or 34 described below is for illustrative purposes, and is not intended to be limiting, as any of modules 22, 24, 26, 28, 32, and/or 34 may provide more or less functionality than is described. For example, one or more of modules 22, 24, 26, 28, 32, and/or 34 may be eliminated, and some or all of its functionality may be provided by other ones of modules 22, 24, 26, 28, 32, and/or 34. As another example, processor(s) 20 may be configured to execute one or more additional modules that may perform some or all of the functionality attributed below to one of modules 22, 24, 26, 28, 32, and/or 34.

Virtual store server(s) 12 may communicate with one or more of servers 2, 3, and 4, configured to provide virtual environments 2a, 3a, and 4a, respectively, to complete a purchasing transaction of a virtual good from transaction system 10.

Server 2 may be configured to provide virtual environment 2a for one or more users, which may include hosting virtual environment 2a over a network. Similarly, servers 3 and 4 may be configured to provide virtual environments 3a and 4a, respectively. The scope of this disclosure is not limited in any way by the implementation or architecture of virtual environments such as virtual environments 2a, 3a, and 4a. Virtual environments 2a, 3a, and 4a may be similar and/or different in terms of implementation and/or architecture. Virtual environments 2a, 3a, and 4a may provide access to each other. Server 2 may include one or more of an environment module 42, an account module 52, a purchase module 62, and/or other constituent components. Server 3 may include one or more of an environment module 43, an account module 53, a purchase module 63, and/or other constituent components. Server 4 may include one or more of an environment module 44, an account module 54, a purchase module 64, and/or other constituent components.

Environment modules 42, 43, and 44 may be configured to implement instances of the respective virtual environments, which may be executed to determine views of the respective virtual environments. The views may then be communicated (e.g., via streaming, via object/position data, and/or other information) from servers 2, 3, and 4 to client computing platforms 14 for presentation to users. The view determined and transmitted to a given client computing platform 14 may correspond to a user character being controlled by a user via the given client computing platform 14. The view determined and transmitted to a given client computing platform 14 may correspond to a location in a particular virtual environment (e.g., the location from which the view may be taken, the location the view depicts, and/or other locations), a zoom ratio, a dimensionality of objects, a point-of-view, and/or view parameters. One or more of the view parameters may be selectable by the user.

An instance of virtual environments 2a, 3a, or 4a may comprise a simulated space that may be accessible by users via clients (e.g., client computing platforms 14) that present the views of the respective virtual environment to a user. The simulated space may have a topography, express ongoing real-time interaction by one or more users, and/or include one or more objects positioned within the topography that are capable of locomotion within the topography. In some instances, the topography may be a 2-dimensional topography. In other instances, the topography may be a 3-dimensional topography. The topography may include dimensions of the space, and/or surface features of a surface or objects that are “native” to the simulated space. In some instances, the topography may describe a surface (e.g., a ground surface) that runs through at least a substantial portion of the simulated space. In some instances, the topography may describe a volume with one or more bodies positioned therein (e.g., a simulation of gravity-deprived space with one or more celestial bodies positioned therein). An instance of virtual environments 2a, 3a, or 4a may be synchronous, asynchronous, and/or semi-synchronous.

The above description of the manner in which views of virtual environments 2a, 3a, and 4a are determined by environment modules 42, 43, and 44 is not intended to be limiting. Environment modules 42, 43, and 44 may be configured to express the respective virtual environments (and/or any virtual objects therein) in a more limited, or more rich, manner. For example, views determined for a given virtual environment may be selected from a limited set of graphics depicting an event in a given place within the given virtual environment. The views may include additional content (e.g., text, audio, pre-stored video content, and/or other content) that describes particulars of the current state of the place, beyond the relatively generic graphics. For example, a view may include a generic battle graphic representation with a textual description of the opponents to be confronted. Other expressions of individual places, actions, and/or virtual objects within virtual environments 2a, 3a, and 4a are contemplated.

Within the instance(s) of virtual environments 2a, 3a, and 4a, implemented by environment modules 42, 42, and 44, respectively, users may control characters, (virtual) objects, simulated physical phenomena (e.g., wind, rain, earthquakes, and/or other phenomena), and/or other elements within the respective virtual environments to interact with the virtual environments and/or each other. The user characters may include avatars. As used herein, the term “user character” may refer to an object (or group of objects) present in a virtual environment that represents an individual user. The user character may be controlled by the user with which it may be associated. The user-controlled element(s) may move through and interact with the virtual environment (e.g., non-user characters in the virtual environment, objects in the virtual environment). The user-controlled elements controlled by and/or associated with a given user may be created and/or customized by the given user. The user may have an inventory of virtual goods and/or currency that the user can use (e.g., by manipulation of a user character or other user controlled element, and/or other items) within the virtual environment.

Users may participate in instances of virtual environments 2a, 3a, and/or 4a by controlling one or more of the available user-controlled elements in a given virtual environment. Control may be exercised through control inputs and/or commands input by the users through client computing platforms 14. The users may interact with each other through communications exchanged within a given virtual environment. Such communications may include one or more of textual chat, instant messages, private messages, voice communications, and/or other communications. Communications may be received and entered by the users via their respective client computing platforms 14. Communications may be routed to and from the appropriate users through servers 2, 3, and/or 4 (e.g., through environment modules 42, 43, and/or 44).

In some implementations, one or more of virtual environments 2a, 3a, and/or 4a may include interactive, electronic social media. Interactive, electronic social media may include one or more of a social network, a virtual space, a micro-blogging service, a blog service (or host), a browser-based game, a multi-player mobile game, a file (e.g., image file, video file, and/or other files) sharing service, a messaging service, a message board, a forum, and/or other electronically distributed media that are scalable and enable interaction between the users. Some non-limiting specific examples of interactive, electronic social media may include the micro-blogging service provided by Twitter™, the social network provided by Facebook™, the social network provided by MySpace™, the social network provided by Foursquare®, the virtual world provided by SecondLife®, the massively multi-player online game provided by World of Warcraft® or Club Penguin®, the social game FarmVille™, the file sharing service provided by Flickr®, Blogger, YouTube, PlayStation® Home, Xbox® Live, and/or other interactive electronic social media.

Account modules 52, 53, and 54 of server 2, 3, and 4, respectively, may be configured to manage (storage for and/or access to) external account information related to a user account for virtual environment 2a, 3a, and 4a, respectively. External account information may include information identifying a user (e.g. a username or handle, a number, an identifier, and/or other identifying information), user information, subscription information, virtual currency account information (e.g., related to currency held in credit for a user), relationship information (e.g., information related to relationships between users in a virtual environment), usage information, demographic information, settings, preferences, customizations, and/or other external account information related to a user account for virtual environment 2a, 3a, and 4a, respectively. External account information of a user may be (made) available to transaction system 10 (e.g. to user account module 24) pursuant to a user of transaction system 10 providing account identifiers corresponding to user account associated with one or more of virtual environments 2a, 3a, and 4a. Usage of external account information may be subject to user authorization.

Purchase modules 62, 63, and 64 of server 2, 3, and 4, respectively, may be configured to present a user with a set of virtual goods for purchase that may be expressed in virtual environments 2a, 3a, and 4a, respectively. Alternatively, and/or simultaneously, purchase modules 62, 63, and 64 may provide a purchase interface into transaction system 10 to accommodate users to purchase virtual goods through transaction system 10. Such a purchase interface may be integrated into the interface of a particular virtual environment, and/or provided by transaction system 10, e.g. through one or more APIs, a plug-in, and/or another way to combine separate interfaces.

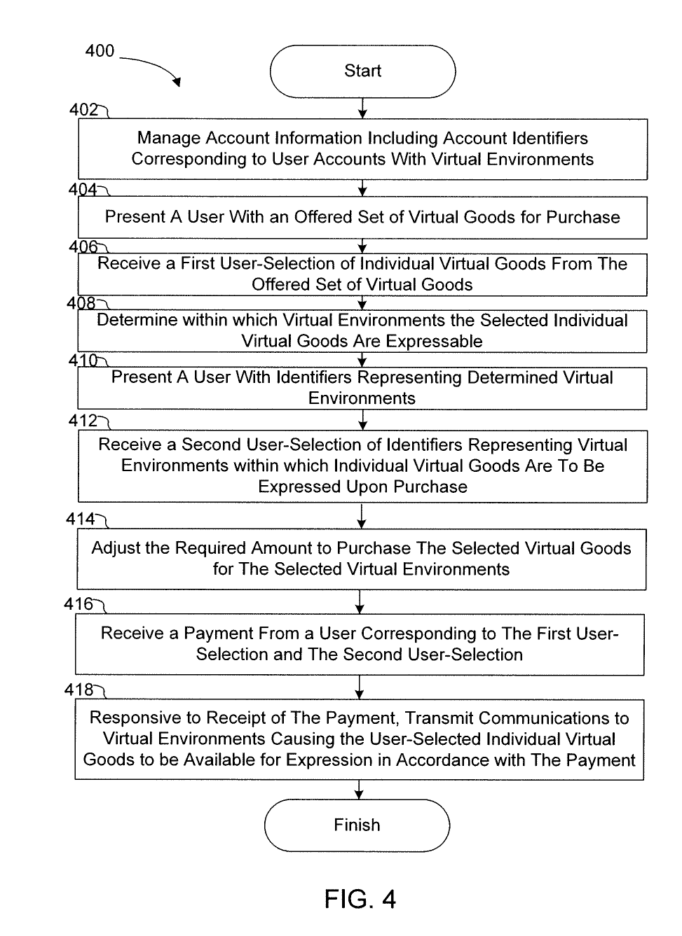

FIG. 4 illustrates a method 400 for conducting purchase transactions in accordance with one or more implementations. The operations of method 400 presented below are intended to be illustrative. In some implementations, method 400 may be accomplished with one or more additional operations not described, and/or without one or more of the operations discussed. Additionally, the order in which the operations of method 400 are illustrated in FIG. 4 and described below is not intended to be limiting.

In some implementations, method 400 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 400 in response to instructions stored electronically on an electronic storage medium. The one or more processing devices may include one or more devices configured through hardware, firmware, and/or software to be specifically designed for execution of one or more of the operations of method 400.

At an operation 402, account information of a user is managed, wherein account information includes account identifiers corresponding to user accounts associated with virtual environments. In some implementations, operation 402 may be performed by an user account module the same as or similar to user account module 24 (shown in FIG. 1 and described above).

At an operation 404, a user is presented with an offered set of virtual goods for purchase. In some implementations, operation 404 may be performed by a store module the same as or similar to store module 34 (shown in FIG. 1 and described above).

At an operation 406, a first user-selection is received of individual virtual goods from the offered set of virtual goods. In some implementations, operation 406 may be performed by a store module the same as or similar to store module 34 (shown in FIG. 1 and described above).

At an operation 408, it is determined within which virtual environments the selected individual virtual goods can be expressed. In some implementations, operation 408 may be performed by a store module the same as or similar to store module 34 (shown in FIG. 1 and described above). This determination may be based on the account identifiers, representing user accounts in virtual environments, which may be accessed as part of the account information of a user.

At an operation 410, identifiers representing determined virtual environments are presented to a user. In some implementations, operation 410 may be performed by a store module the same as or similar to store module 34 (shown in FIG. 1 and described above). At an operation 412, a second user-selection is received of identifiers representing virtual environments within which individual goods are to be expressed upon purchase. In some implementations, operation 412 may be performed by a store module the same as or similar to store module 34 (shown in FIG. 1 and described above).

At an operation 414, the required amount to purchase the selected virtual goods for the selected virtual environments is adjusted. In some implementations, operation 414 may be performed by a store module the same as or similar to store module 34 (shown in FIG. 1 and described above).

At an operation 416, a payment is received from a user corresponding to the first user-selection and the second user-selection. In some implementations, operation 416 may be performed by a payment module the same as or similar to currency module 26 (shown in FIG. 1 and described above).

At an operation 418, responsive to receipt of the payment, communications are transmitted to virtual environments causing the user-selected individual virtual goods to be available for expression in accordance with the payment. In some implementations, operation 418 may be performed by an environment interaction module the same as or similar to environment interaction module 32 (shown in FIG. 1 and described above).

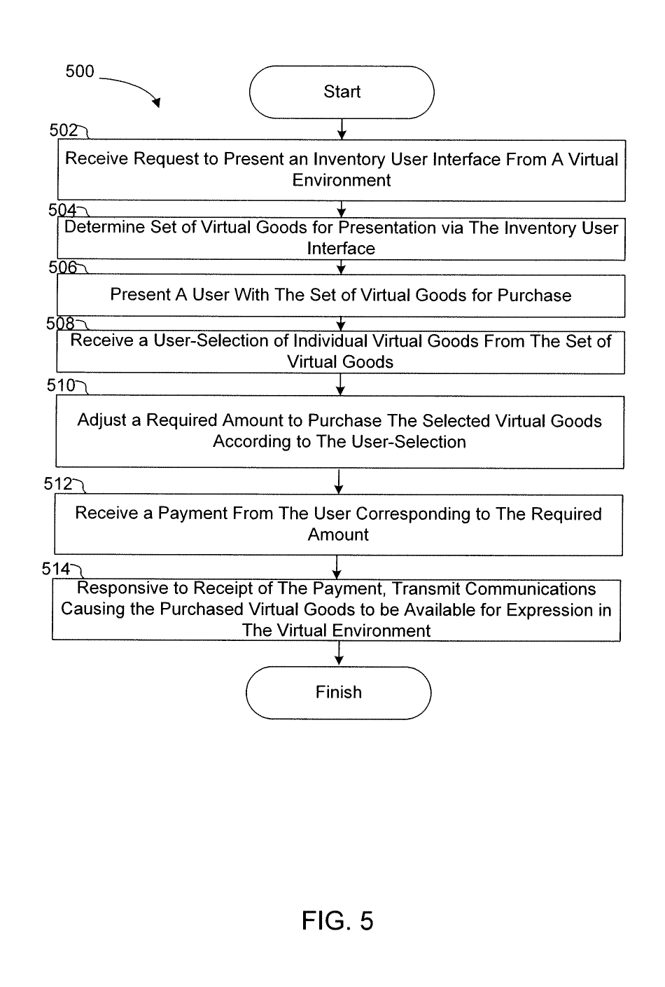

FIG. 5 illustrates a method 500 for conducting purchase transactions in accordance with one or more implementations. Method 500 may be an implementation of conducting a purchase transaction as described in relation to FIG. 3, interface element 320, and/or inventory module 26.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured to conduct purchase transactions, the system comprising:
one or more processors configured to execute computer program modules, the computer program modules comprising:
a user account module configured to manage account information of a user, wherein account information includes one or more account identifiers corresponding to one or more user accounts associated with one or more virtual environments;
a store module configured to present a user with an offered set of virtual goods for purchase, wherein the store module is configured to receive a first user-selection of individual virtual goods included in the offered set of virtual goods, wherein the store module is configured to receive a second user-selection of one or more identifiers representing one or more virtual environments for which one or more individual virtual goods are to be expressed upon purchase, wherein the one or more identifiers are associated with one or more user-selected individual virtual goods;
a payment module configured to receive a payment of an amount from a user, wherein the payment corresponds to the first user-selection and the second user-selection; and
an environment interaction module configured to, responsive to receipt of the payment, transmit communications to the one or more virtual environments indicated in the second user-selection, wherein the communications cause the user-selected individual virtual goods to be available for expression in accordance with the payment.

2. The system of claim 1, wherein the amount of the payment is adjusted based on for which virtual environments a user-selected individual virtual good is to be expressed.

3. The system of claim 1, wherein the store module is further configured to present the user with a set of identifiers representing one or more virtual environments able to express one or more individual virtual goods such that an identifier is associated with a user-selected individual virtual good, and wherein presentation of the set of identifiers is responsive to receipt of the first user-selection.

4. The system of claim 1, wherein inclusion of a given virtual good in the offered set of virtual goods is based on availability of the given virtual good to be expressed in the one or more virtual environments associated with the one or more user accounts corresponding to the one or more account identifiers included in the account information.

5. The system of claim 1, wherein inclusion of a given virtual good in the offered set of virtual goods is based on account status information of a given user account associated with a given virtual environment.

6. The system of claim 1, wherein the one or more virtual environments are external to the system.

7. The system of claim 1, further comprising a user access module configured to manage user access to the system.

8. The system of claim 1, further comprising an inventory module configured to present inventory information to a user in one or more of the virtual store or one or more virtual environments.

9. The system of claim (8), wherein, responsive to receipt of the payment, purchased virtual goods are added to the inventory information.

10. The system of claim (8), wherein the inventory module is further configured to present a user with an offered set of virtual goods for purchase in a virtual environment external to the system.

11. A method for conducting purchase transactions, the method comprising:
managing account information of a user, wherein account information includes one or more account identifiers corresponding to one or more user accounts associated with one or more virtual environments;
presenting a user with an offered set of virtual goods for purchase;
receiving a first user-selection of individual virtual goods included in the offered set of virtual goods;
receiving a second user-selection of one or more identifiers representing one or more virtual environments for which one or more individual virtual goods are to be expressed upon purchase, wherein the one or more identifiers are associated with one or more user-selected individual virtual goods;
receiving a payment of an amount from a user, wherein the payment corresponds to the first user-selection and the second user-selection; and
responsive to receipt of the payment, transmitting communications to the one or more virtual environments indicated in the second user-selection, wherein the communications cause the user-selected individual virtual goods to be available for expression in accordance with the payment.

12. The method of claim 11, wherein the amount of the payment is adjusted based on for which virtual environments a user-selected individual virtual good is to be expressed.

13. The method of claim 11, further comprising:
responsive to receipt of the first user-selection, presenting a user with a set of identifiers representing one or more virtual environments able to express one or more individual virtual goods such that an identifier is associated with a user-selected individual virtual good.

14. The method of claim 11, wherein inclusion of a given virtual good in the offered set of virtual goods is based on availability of the given virtual good to be expressed in the one or more virtual environments associated with the one or more user accounts corresponding to the one or more account identifiers included in the account information.

15. The method of claim 11, wherein inclusion of a given virtual good in the offered set of virtual goods is based on account status information of a given user account associated with a given virtual environment.

16. The method of claim 11, wherein the one or more virtual environments are external to the system.

17. The method of claim 11, further comprising:
managing user authorization prior to presenting the user with the offered set of virtual goods for purchase.

18. The method of claim 11, further comprising:
presenting inventory information to a user in one or more of the virtual store or one or more virtual environments.

19. The method of claim 18, wherein, responsive to receipt of the payment, purchased virtual goods are added to the inventory information.

20. The method of claim 19, further comprising:
presenting a user with an offered set of virtual goods for purchase in a virtual environment external to the system.
